(19) United States
(12) Patent Application Publication
(10) Pub. No.: US 2018/0020649 A1
(43) Pub. Date: Jan. 25, 2018

(54) Fishing rod grip

(71) Applicant: Joseph Kotarsky, Ronco, PA (US)

(72) Inventor: Joseph Kotarsky, Ronco, PA (US)

(21) Appl. No.: 15/213,466

(22) Filed: Jul. 19, 2016

(51) Int. Cl. A01K 87/08

(52) U.S. Cl. CPC A01K 87/08

(57) ABSTRACT

A fishing rod grip generally U-shaped in cross section through a vertical plane to curve around an axis. The main body has a front, a back, a right side, a left side, a front-edge, a rear edge; and an underside. The proximate left top edge extends a greater distance radially from the axis than the proximate right top such that a user's thenar may ergonomically rest against the left side. The distal right top edge is generally S-shaped when viewed trans-axially to define a thumb portion and thumb opening. The thumb portion has a height greater than the distal left top edge to ergonomically accommodate a user's thumb. The thumb opening provides accessibility to a line of the reel. A finger portion extends from the underside to ergonomically accommodate a user's index finger. An optional thumb screw can connect proximate right top edge to proximate left top edge.

### BACKGROUND

### Field of the Invention

The present invention relates to gripping accessories to aid in the grasping and leveraging of fishing rods.

### Description of the Related Art

Fishing rod handle accessories are known in the art. U.S. Pat. No. 6,098,333 to Wickizer et al. shows a leverage feature for a fishing rod extending laterally from the fishing rod handle a short distance to the rear of a reel. The leverage feature has a contoured cupped ridge shape which is inclined to the rear so as to be engaged by the side of the hand when the rod handle is palm gripped during play of a hooked fish to greatly improve the leverage able to be exerted by the hand in resisting the tipping of the rod by the pull of the fish.

U.S. Pat. No. 5,363,586 teaches a fishing rod handle for providing a more comfortable and efficient grip during retrieving which includes two distinct grips, one to be utilized during the casting motion and a separate grip to be utilized during the retrieving motion. The handle includes a reel sent on which a fishing reel is mounted, and a casting grip defined on the handle behind the reel position.

U.S. Pat. No. 6,237,274 to Head et al. describes a fishing rod handle attachment comprised of a handle, a handle extension for position the handle directly above the fishing rod, and an attaching device for rigidly attaching the handle attachment to the fishing rod. The handle is comprised of an elongated member and a support member. The elongated member is gripped by a user's hand while the user is fishing, the elongated member being transverse to the fishing rod, horizontally oriented, and positioned directly above the fishing rod when the fishing rod is being used for fishing.

U.S. Pat. No. 7,854,086 to Huynh shows a fishing rod with ergonomic handle. The disclosed fishing rod places the angler's wrist in a more ergonomically correct position while waiting for a fish to strike. To accomplish this the fishing rod includes a flexible rod including a plurality of ferrules extending downward; a handle including a primary handle substantially parallel to and vertically above the flexible rod and a secondary handle extending upwards from the primary handle.

U.S. Pat. Publication No. 2006/010102 to LaCoste teaches a handle for bait-casting type fishing rods, with a preferred embodiment including a single-piece, lightweight, contoured pistol-grip type handle located on the rod ahead of the reel to afford the user fishing sensitivity due to direct finger contact with the fishing line extending from the reel.

The above and other prior art handle accessories suffer generally in that they are cumbersome and detract from the traditional look and use of a fishing pole. In addition, they are bulky to the extent the rods cannot be used within rod holders.

### SUMMARY

Accordingly, the invention comprehends a fishing rod grip comprising a main body generally U-shaped in cross section through a vertical plane to curve around an axis. The main body has a front, a back, a right side (down rod), a left side, a front-edge, a rear edge; and an underside. The back is defined by a proximate half, wherein the proximate half has a proximate right top edge and a proximate left top edge. The front is defined by a distal half, the distal half having a distal right top edge and a distal left top edge. The proximate left top edge extends a greater distance radially from the axis than the proximate right top such that a user's thenar may ergonomically rest against the left side. The distal right top edge is generally S-shaped when viewed trans-axially to define a thumb portion and thumb opening. The thumb portion has a height greater than the distal left top edge to ergonomically accommodate a user's thumb. The thumb opening provides accessibility to a line of the reel. A finger portion extends from the underside to ergonomically accommodate a user's index finger. An optional thumb screw can connect proximate right top edge to proximate left top edge.

### BRIEF DESCRIPTION OF THE DRAWINGS

FIG. 1 shows a perspective view of the instant fishing rod grip in use on a fishing rod.

FIG. 2 shows a bottom view in elevation.

FIG. 3 shows a top view in elevation.

FIG. 4 shows a left side view in elevation.

FIG. 5 shows a right side view in elevation.

FIG. 6 shows a rear view thereof.

FIG. 7 shows a front view thereof.

### DETAILED DESCRIPTION OF THE PREFERRED EMBODIMENT

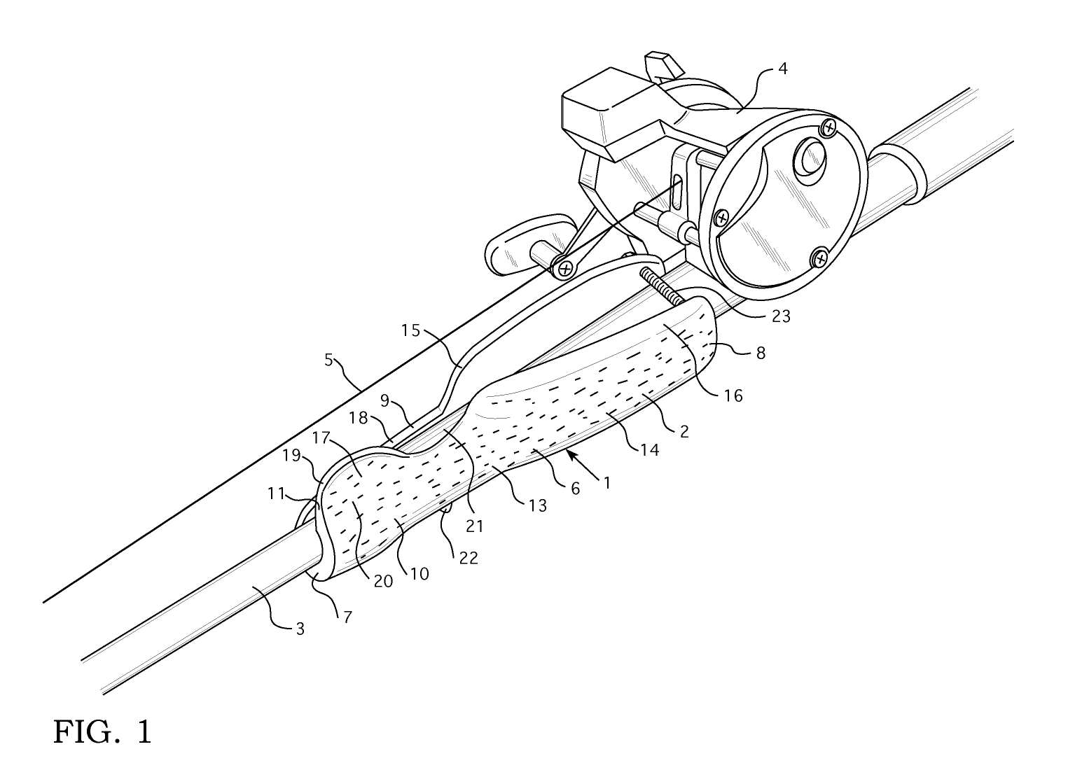

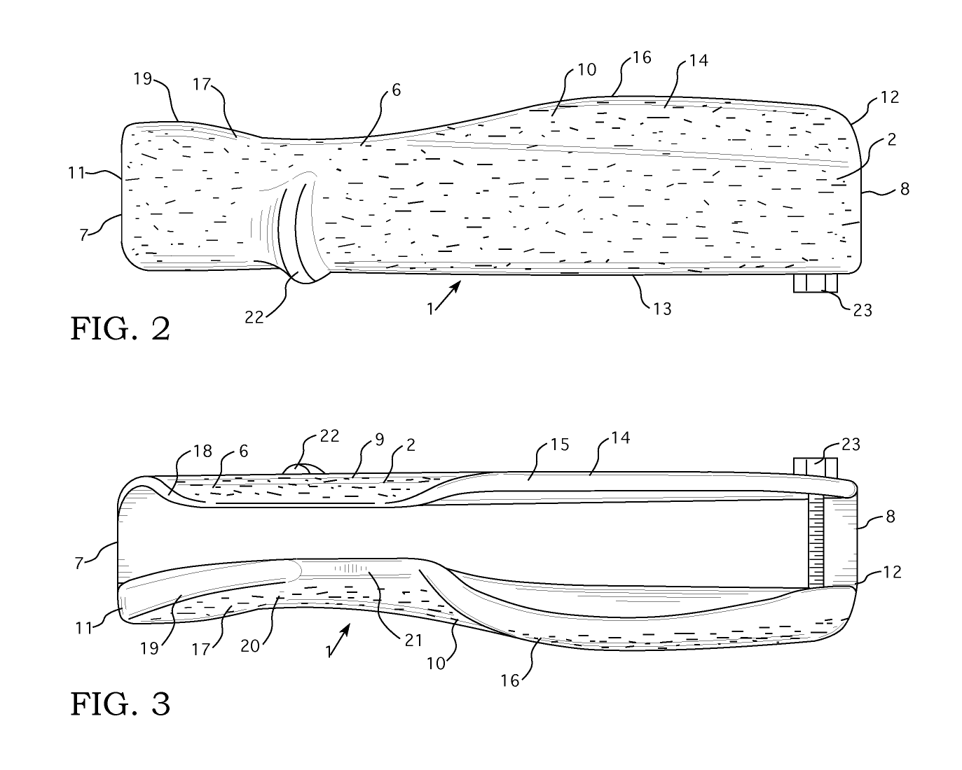

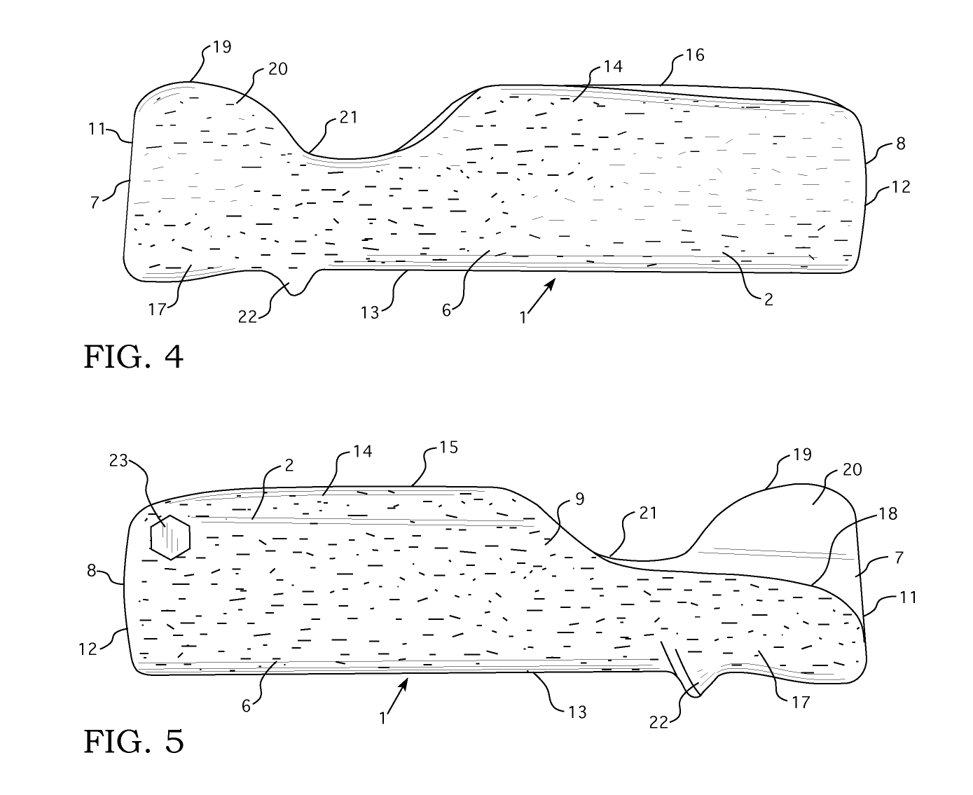

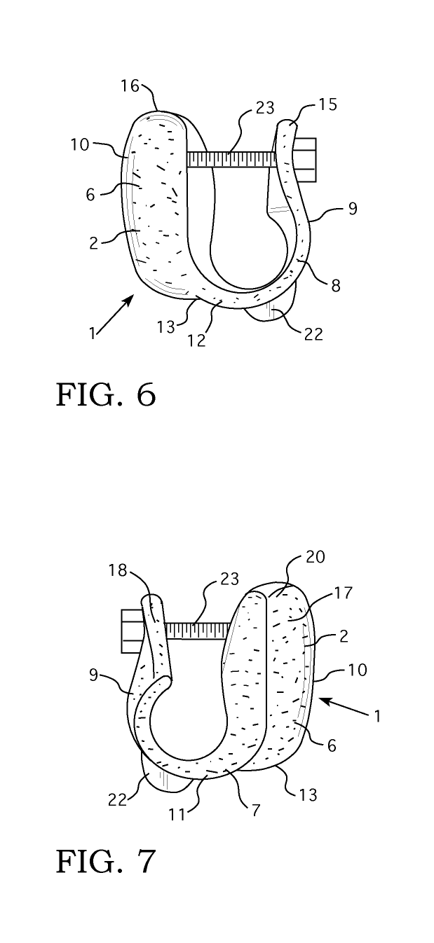

Now with reference to FIGS. 1-7, shown is the instant fishing rod grip 1 for use with a fishing rod 3 having a reel 4 with fishing line 5. Grip 1 may be deployed on any type of fishing rod 3 such as one including a level wind reel. Additionally, leveraging capabilities during action may be desirable on rods 3 having a higher power value. Grip 1 is preferably made of a lightweight plastic or composite, although any lightweight rigid or semi-rigid material can be used. Grip 1 is adapted to temporarily or permanently fix on to rod 3 just beyond reel 4 as shown such that a user (fishermen) can grasp the grip 1 with his or her left hand, although it should be understood that the grip 1 can be designed for right-handed use as well simply by producing a mirror image of grip 1. Outer surface 2 of grip 1 can be textured as desired to aid grip using any type and form of surface texturing.

Grip 1 includes a main body 6 generally U-shaped in cross section through a vertical plane to curve around an axis, vertical plane meaning if rod 3 is the axis, or disposed axially, vertical plane trans-sects the rod 3. Thus, axially means along the rod, or down-rod, so main body 6 curves around to at least partially envelope rod 3 as shown.

Main body 6 has a front 7, a back 8, a right side 9 (when viewed down rod, although not meant to be limiting based on a change of left hand or right hand orientation), a left side 10, a front-edge 11, a rear edge 12; and an underside 13. The back 8 is defined by a proximate half 14, proximate meaning in relation to reel 4. So proximate half 14 has a proximate right top edge 15 and a proximate left top edge 16. The front 7 would be defined by a distal half 17 (more down-rod away from reel 4), the distal half 17 having a distal right top edge 18 and a distal left top edge 19.

As shown, the distal right top edge 18 is generally S-shaped when viewed trans-axially (laterally) to define a thumb portion 20 and a thumb opening 21. In this manner, the thumb portion 20 has a height greater than the distal left top edge 19 to ergonomically accommodate a user's thumb, which is advantageous for grip and leveraging purposes as thumb portion 20 allows for additional hand leverage and rotational force. The thumb opening 21 allows the user's thumb to rest therethrough and over rod 3, reaching to proximate right top edge 15, thus the proximate right top edge 15 at this location could, optionally, have additional texturing or surface indicia. The thumb opening 21 also aids to provide accessibility to the fishing line 5 as it travels through main body 6 such that the grip 1 does not completely shield the line 5, the feel and access of which is critical, especially for line guiding on reels. Lastly, the thumb opening 21 allows for the security clamp of particular rod holders to open and close, thus the rod 3, while still equipped with the grip 1, can be held within a boat or dock rod holder. The proximate left top edge 16 extends a greater distance radially from the axis than the proximate right top edge 15. In this manner, main body 6 is asymmetric and the user's thenar may more ergonomically rest against the left side 10, advantageous for comfort and leveraging purposes.

In optional embodiments, a finger portion 22 extends from the underside 13 to ergonomically accommodate a user's index finger and thus provide a means for additional leverage. Additional grip members of varying height and depth can be employed behind finger portion 22 as desired for the user's other fingers. Accordingly, with this and the above shape characteristics, all points of contact from the user's hand are utilized while grasping and using the grip 1. Although the grip 1 can be deployed and maintained along rod 3 by friction, an optional thumb screw 23 or any type of fastener can connect through or near proximate right top edge 15 and proximate left top edge 19 to maintain, tighten and loosen the grip 1 about rod 3.

In use then, user cups grip 1 around rod 3 either at the point of insertion or at a down-rod location, then slides and (optionally) fixes the grip 1 in place slightly forward of reel 4 or at a desired location proximate to left (or right) hand placement such that grip and leveraging is enhanced during rod 3 action and play.

I claim:

1. A fishing rod grip, comprising:
a main body generally U-shaped in cross section through a vertical plane to curve around an axis;
said main body having a front, a back, a right side, a left side, a front edge, a rear edge, and an underside;
said back defined by a proximate half, wherein said proximate half has a proximate right top edge and a proximate left top edge,
said front defined by a distal half, said distal half having a distal right top edge and a distal left top edge; and,
said proximate left top edge extending a greater distance radially from the axis than said proximate right top such that a user's thenar may ergonomically rest against said left side.

2. The fishing rod grip of claim 1, further comprising a thumb screw connecting said proximate right top edge to said proximate left top edge.

3. The fishing rod grip of claim 1, further comprising a textured outer surface.

4. A fishing rod grip, comprising:
a main body generally U-shaped in cross section through a vertical plane to curve around an axis;
said main body having a front, a back, a right side, a left side, a front-edge, a rear edge; and an underside;
said back defined by a proximate half, wherein said proximate half has a proximate right top edge and a proximate left top edge,
said front defined by a distal half, said distal half having a distal right top edge and a distal left top edge;
said distal right top edge generally S-shaped when viewed trans-axially to define a thumb portion and a thumb opening;
said thumb portion having a height greater than said distal left top edge to ergonomically accommodate a user's thumb; and,
said thumb opening providing accessibility to a line of a reel.

5. The fishing rod grip of claim 5, further comprising a thumb screw connecting said proximate right top edge to said proximate left top edge.

6. The fishing rod grip of claim 5, further comprising a textured outer surface.

7. A fishing rod grip, comprising:
a main body generally U-shaped in cross section through a vertical plane to curve around an axis;
said main body having a front, a back, a right side, a left side, a front-edge, a rear edge; and an underside;
said back defined by a proximate half, wherein said proximate half has a proximate right top edge and a proximate left top edge,
said front defined by a distal half, said distal half having a distal right top edge and a distal left top edge; and,
a finger portion extending from said underside to ergonomically accommodate a user's index finger.

8. The fishing rod grip of claim 7, further comprising a thumb screw connecting said proximate right top edge to said proximate left top edge.

9. The fishing rod grip of claim 7, further comprising a textured outer surface.
